(19) United States
(12) Patent Application Publication
(10) Pub. No.: US 2006/0176853 A1
(43) Pub. Date: Aug. 10, 2006

(54) Handover management apparatus and method for heterogeneous wireless networks

(75) Inventors: Xiaoyu Liu, Yongin-si (KR); Hee-jin Jang, Yongin-si (KR); Youn-hee Han, Guri-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/257,104

(22) Filed: Oct. 25, 2005

(30) Foreign Application Priority Data
Feb. 7, 2005 (KR) 2005-11368

(51) Int. Cl. H04Q 7/00

(52) U.S. Cl. 370/331

(57) ABSTRACT

A handover management apparatus and method for heterogeneous networks is provided. The handover management method includes receiving a handover request notification from a serving access node (AN) that is located in a first wireless network and connected to a mobile node (MN) and extracting information from the received handover request notification. The extracted information relates to a target AN that is located in a second wireless network heterogeneous from the first wireless network. The method further includes changing the target AN, which is discovered from the extracted information, to an AN of the MN and storing information associating the mobile node with the target access node.

### CROSS-REFERENCE TO RELATED APPLICATIONS

This application claims priority from Korean Patent Application No. 2005-11368 filed on Feb. 7, 2005 in the Korean Intellectual Property Office, the entire disclosure of which is incorporated herein by reference.

### BACKGROUND OF THE INVENTION

1. Field of the Invention

Apparatuses and methods consistent with the present invention relate generally to handover management, and more particularly, to handover management to enable fast handover between heterogeneous wireless networks.

2. Description of the Related Art

The prevalence of Internet, the development of wireless communication technology, and the performance enhancement of mobile terminals such as personal computers and personal digital assistants (PDAs) has lead to an increased number of wireless Internet users. Under the wireless Internet environment, mobile terminals may be moved between different locations and therefore may change their network access points.

To enable wireless Internet communications for mobile terminals, a high quality of Internet services must be ensured in a new network environment as in the current network environment. That is, the mobile terminal must be able to sustain seamless communications. In response to this requirement, handovers have been introduced. A handover is the handing over of communications from an access node (AN) of one network area to an AN of another network area.

As a mobile terminal moves around, the handover to a heterogeneous network may be required. For instance, a mobile terminal may be handed from a wireless local area network (WLAN) to a wireless metropolitan area network (WMAN).

The layer 3 may be responsible for the handover between the heterogeneous networks, but this takes too much time for such a handover.

Therefore, there is a demand for fast handovers between heterogeneous networks.

### SUMMARY OF THE INVENTION

An aspect of the present invention provides an apparatus and method for fast handover between heterogeneous networks.

To achieve the above aspect and/or features of the present invention, a handover management method includes: receiving a handover request notification from an AN that is located in a first wireless network and connected to an MN; extracting information relating to a target AN, located in a second wireless network heterogeneous from the first wireless network, from the received handover request notification; and setting the target AN, which is discovered from the extracted target AN information, as an AN of the MN. The method may further include storing information associating the MN with the target AN.

The handover management method may further include: receiving a packet destined for the MN; retrieving the stored information associating the MN with the target AN; retrieving information associating the target AN with a port connected to the retrieved AN; and outputting the received packet to the port associated with the target AN.

The outputting of the received packet may include converting the received packet to a packet conforming to a protocol of the second wireless network if the received packet destined for the MN conforms to a protocol of the first wireless network; and outputting the converted packet to the port associated with the target AN.

The second wireless network may be wireless Internet. The first wireless network may be one of a WLAN and a WMAN, and the second wireless network may be the other of the WLAN and the WMAN.

In accordance with the another exemplary aspect of the present invention, a handover management apparatus includes: a first interface section providing a communication interface with an AN located in a first wireless network; a second interface section providing a communication interface with a AN located in a second wireless network that is heterogeneous from the first wireless network; and a an MN management section setting the target AN, which is located in the second wireless network and discovered from handover request notification transmitted to the first interface section, as an AN of an MN. The MN management section may further store information associating the MN with the target AN.

The handover management apparatus may further include a packet forwarding section receiving a packet destined for the MN, retrieving the stored information associating the MN with the target AN, retrieving information associating the target AN with a port among ports of the first and second interface sections, and outputting the received packet to the port associated with the target AN.

The packet forwarding section may convert the received packet to a packet conforming to a protocol of the second wireless network if the received packet destined for the MN conforms to a protocol of the first wireless network, and may output the converted packet to the port associated with the target AN.

The second wireless network may be wireless Internet. The first wireless network may be one of a WLAN and a WMAN, and the second wireless network may be the other of the WLAN and the WMAN.

### BRIEF DESCRIPTION OF THE DRAWINGS

These and/or other aspects and advantages of the invention will become apparent and more readily appreciated from the following description of exemplary embodiments, taken in conjunction with the accompanying drawings of which:

FIG. 1 is a diagram of an internetwork to which the present invention is applicable;

FIG. 2 is a block diagram of a handover management apparatus for heterogeneous networks according to an exemplary embodiment of the present invention;

FIG. 3 is a sequence chart explaining a handover management method for the heterogeneous networks according to an exemplary embodiment of the present invention;

FIG. 4A is an exemplary MN-AN table stored in a storage section before s handover of an MN1;

FIG. 4B is an exemplary AN-PORT table stored in the storage section before a handover of an MN1; and

FIG. 4C is an exemplary MN-AN table stored in the storage section after a handover of an MN1.

### DETAILED DESCRIPTION OF THE EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

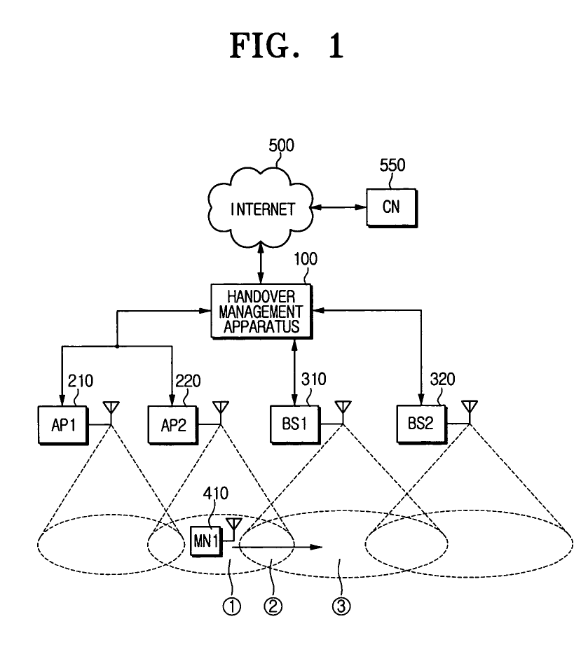

FIG. 1 is a diagram of a configuration of an internetwork to which the present invention is applicable. The internetwork is configured with interconnections among a WLAN established based on access points (APs) 210 and 220, a WMAN established based on base stations (BSs) 310 and 320, and Internet 500. Representative examples of the WMAN include wireless Internet serviced by proprietary companies or government companies.

A handover management apparatus 100 is located at the center of the internetwork. The handover management apparatus 100 is responsible for the management of a fast handover of an MN 410 that is located within the WLAN or the WMAN. If the MN is handed over to a heterogeneous network, for example, if the MN is handed from the WLAN to the WMAN or vice versa, the handover management apparatus 100 enables a fast handover.

In addition, the handover management apparatus 100 enables packet transmission to the MN regardless of which wireless network the MN is located in.

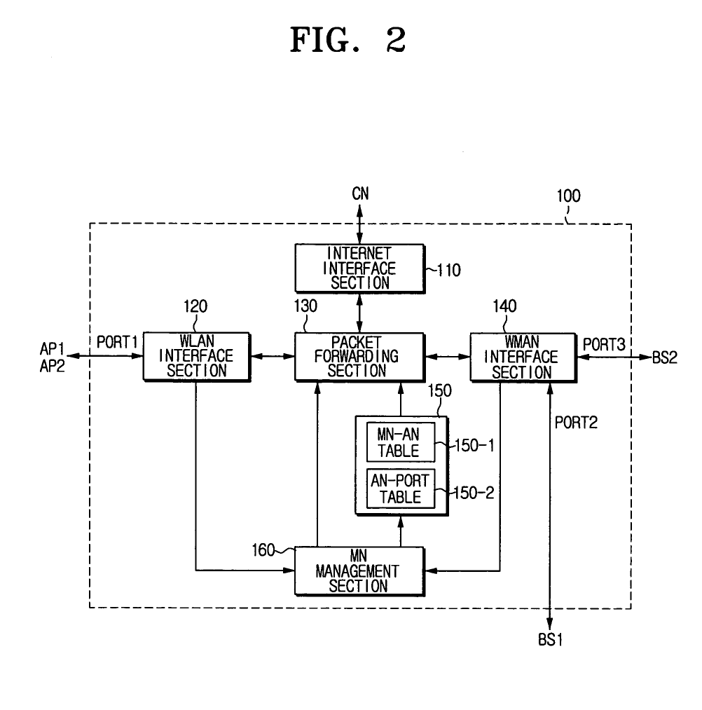

The following is a further explanation of the handover management apparatus 100 in reference to FIG. 2. FIG. 2 is a block diagram of the handover management apparatus 100 according to an exemplary embodiment of the present invention.

In FIG. 2, the handover management apparatus 100 includes an Internet interface section 110, a WLAN interface section 120, a packet forwarding section 130, a WMAN interface section 140, a storage section 150, and an MN management section 160. The storage section 150 stores an MN-AN table 150-1 and an AN-PORT table 150-2.

The Internet interface section 110 provides a communication interface with nodes over the Internet 500.

The WLAN interface section 120 provides a communication interface with the APs 210 and 220 over the WLAN. The WLAN interface section 120 is linked to the AP1 210 and the AP2 220 through the port1.

The WMAN interface section 140 provides a communication interface with the BSs 310 and 320 over the WMAN. The WMAN interface section 140 is linked to the BS1 310 through the port2 and to the BS2 320 through the port3.

The packet forwarding section 130 forwards a packet received from outside, to the MN. In forwarding the packet, the packet forwarding section 130 refers to the tables 150-1 and 150-2 stored in the storage section 150.

Specifically, the packet forwarding section 130, upon receiving a packet destined for the MN, retrieves the AN connected to the MN by referencing the MN-AN table 150-1. The MN-AN table 150-1 stores associations between the MNs and the ANs connected to the MNs.

The packet forwarding section 130 retrieves the port connected to the retrieved AN by referencing the AN-PORT table 150-2. The AN-PORT table 150-2 stores association between the ANs and the ports connected to the ANs.

The packet forwarding section 130 converts the received packet into a packet in compliance with the protocol of the wireless network of the MN. For instance, if the received packet is compliant with the protocol of the Internet 500 and the MN is located in the WLAN, the packet forwarding section 130 converts the received packet into a WLAN protocol-compliant packet. If the received packet is compliant with the protocol of the Internet 500 and the MN is located in the WMAN, the packet forwarding section 130 converts the received packet into a WMAN protocol-compliant packet.

Next, the packet forwarding section 130 outputs the converted packet to the retrieved port so that the packet can be delivered to the MN.

The MN management section 160 properly maintains the MN-AN table 150-1 stored in the storage section 150 so that the packet forwarding to the MN may be properly executed.

When the MN is handed over, the MN management section 160 updates the MN-AN table 150-1 so that packet forwarding to the MN is not interrupted. To this end, the MN management section 160 changes the AN of the MN to a target AN in the MN-AN table 150-1 to update the MN-AN table 150-1 in case of the MN handover.

In the following description, the exemplary handover management method is illustrated for when an MN1 410, which communicates with a correspondent node (CN) 550, moves from an area \textcircled{1} to an area \textcircled{3} via an area \textcircled{2} and is handed from the WLAN to the WMAN as illustrated in FIG. 1.

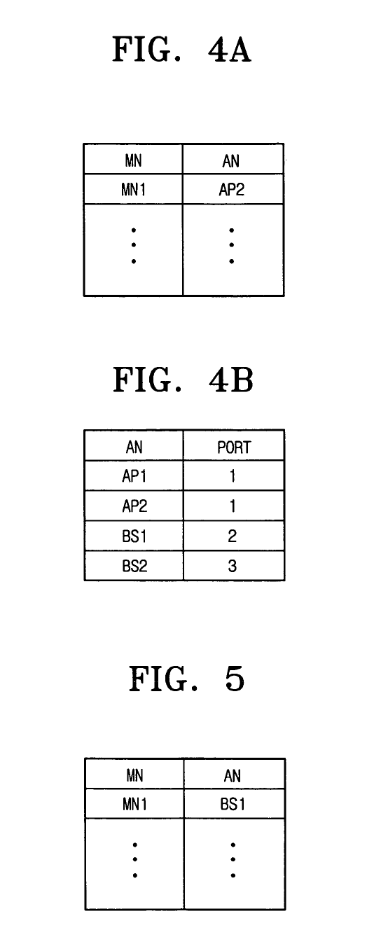

When the MN1 410 is located in the area \textcircled{1}, the AN of the MN1 410 is the AP2 220, the information for which is stored in the MN-AN table 150-1 of FIG. 4A. In reference to FIG. 1 and FIG. 2, the AN-PORT table 150-2 is set up as shown in FIG. 4B.

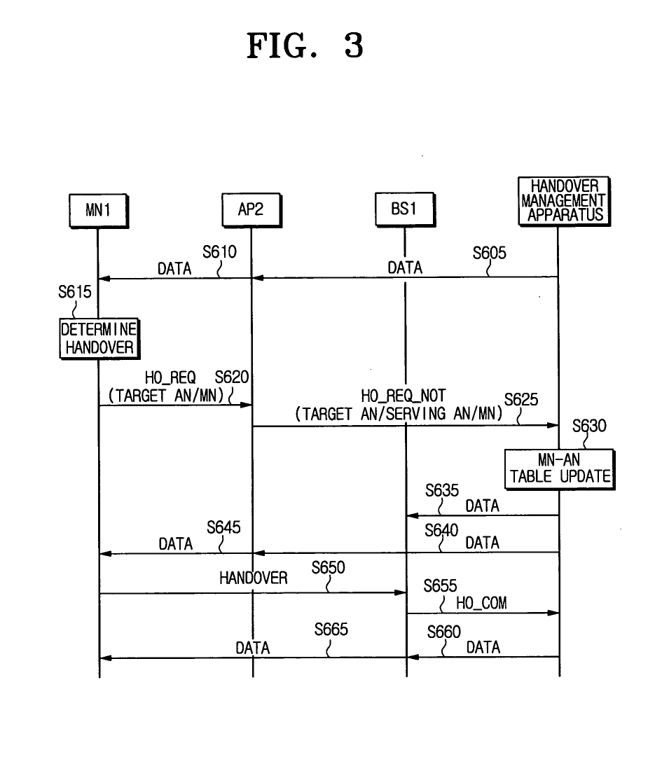

FIG. 3 is a sequence chart explaining the handover management method between the heterogeneous networks according to an exemplary embodiment of the present invention.

In FIG. 3, the packet forwarding section 130 of the handover management apparatus 100 forwards, to the AP2 220, the data packet received from the CN 550 via the Internet interface section 110 (S605).

In more detail, the packet forwarding section 130 learns that the MN1 410 is linked to the AP2 220 based on the MN-AN table 150-1 of FIG. 4A, and that the AP2 220 is connected to the port1 based on the AN-PORT table 150-2 of FIG. 4B.

The packet forwarding section 130 converts the data packet from the CN 550, which conforms to the protocol of the Internet 550, to a WLAN protocol-compliant data packet.

Next, the packet forwarding section 130 outputs the WLAN protocol-compliant data packet to the port1 to forward the data packet to the AP2 220.

The AP2 220 transmits the received data packet to the MN1 410 (S610).

When the MN1 410 determines the handover from the WLAN to the WMAN because of movement from the area \textcircled{1} to the area \textcircled{2} (S615), the MN1 410 transmits a handover request HO_REQ packet to the AP2 220 being a serving AN (S620). The HO_REQ packet contains information relating to the target AN (BS1) and information relating to the MN (i.e., the IP address of the MN1).

Next, the AP2 220 transmits a handover request notification HO_REQ_NOT packet to the handover management apparatus 100 (S625). The HO_REQ_NOT packet contains information relating to the serving AN (AP2) in addition to the information relating to the target AN (BS1) and the information relating to the MN (IP address of the MN1).

The MN management section 160 of the handover management apparatus 100 updates the MN-AN table 150-1 using the information contained in the HO_REQ_NOT packet (S630). Specifically, the MN management section 160 changes the AN of the MN from the serving AN (AP2) to the target AN (BS1) to update the MN-AN table 150-1. The updated MN-AN table 150-1 is shown in FIG. 5.

Next, the MN management section 160 controls the packet forwarding section 130 to forward the data packet received from the CN 550 to both the AP2 220 (as the serving AN of the MN1 410) and the BS1 310 (as the target AN) (S635 and S640). The AP2 220, as the serving AN of the MN1 410, transmits the forwarded data packet to the MN1 400 (S645).

When the MN1 410 is handed over from the WLAN to the WMAN, that is, when the MN1 410 is disconnected from the AP2 220 and is connected to the BS1 310 (S650), the BS1 310 transits a handover complete HO_COM packet to the handover management apparatus 100 (S655).

The MN management section 160 of the handover management apparatus 110 can recognize the handover completion of the MN1 410 from the received HO_COM packet. The MN management section 160 then controls the packet forwarding section 130 to forward data packets received from the CN 550 to only the BS1 310 (S660).

Specifically, the packet forwarding section 130 learns the connection between the MN1 410 and the BS1 310 from the MN-AN table 150-1 of FIG. 5, and the connection between the BS1 310 and the port2 from the AN-PORT table 150-2 of FIG. 4B.

Then, because a data packet received from the CN 550 is compliant with the protocol of the Internet 500, the packet forwarding section 130 converts the data packet to the WMAN protocol-compliant data packet.

Next, the packet forwarding section 130 outputs the WMAN protocol-compliant data packet to the port2 to forward the data packet to the BS1 310.

The BS1 310 transmits the forwarded data packet to the MN1 410 (S665).

Consequently, the MN1 410 can continue to receive data packets even when the MN1 410 is handed over from the WLAN to the WMAN. Since the handover of the MN1 410 is carried out by the handover management apparatus 100 connected to both the WLAN and the WMAN, a fast handover can be realized.

As set forth above, the handover management apparatus that is connected to all of the heterogeneous wireless networks manages the handover between the heterogeneous wireless networks. As a result, a fast handover can be achieved.

Although a few exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A handover management method comprising:
receiving a handover request notification from a serving access node that is located in a first wireless network and connected to a mobile node;
extracting information from the received handover request notification, wherein the extracted information relates to a target access node that is located in a second wireless network heterogeneous from the first wireless network; and
setting the target access node of the extracted target AN information, as an access node of the mobile node.

2. The handover management method of claim 1, wherein the setting comprises storing information associating the mobile node with the target access node.

3. The handover management method of claim 2, further comprising:
receiving a packet destined for the mobile node;
retrieving the stored information associating the mobile node with the target access node;
retrieving information associating the target access node with a port; and
outputting the received packet to the port associated with the target access node.

4. The handover management method of claim 3, wherein the outputting of the received packet comprises:
if the received packet destined for the mobile node conforms to a protocol of the first wireless network, converting the received packet to a packet conforming to a protocol of the second wireless network in which the MN is located; and
outputting the converted packet to the port associated with the target node.

5. The handover management method of claim 1, wherein the second wireless network is wireless Internet.

6. The handover management method of claim 1, wherein
the first wireless network is one of a wireless local area network and a wireless metropolitan area network, and
if the first wireless network is the wireless local area network, the second wireless network is a wireless metropolitan area network, and if the first wireless network is the wireless metropolitan area network, the second wireless network is a wireless local area network.

7. A handover management apparatus comprising:
a first interface section which provides a communication interface with an access node located in a first wireless network;
a second interface section which provides a communication interface with an access node located in a second wireless network that is heterogeneous from the first wireless network; and
a mobile node management section which sets the target access node as an access node of the mobile node.

8. The handover management apparatus of claim 7, wherein the mobile node management section further stores information associating the mobile node with the target access node.

9. The handover management apparatus of claim 8, further comprising:
a packet forwarding section which receives a packet destined for the MN,
retrieves the stored information associating the mobile node with the target access node, retrieves information associating the target access node to a port, and outputs the received packet to the port associated with the target access node.

10. The handover management apparatus of claim 9, wherein the packet forwarding section:
converts the received packet to a packet conforming to a protocol of the second wireless network in which the mobile node is located if the received packet destined for the mobile conforms to a protocol of the first wireless network, and
outputs the converted packet to the port associated with the target access node.

11. The handover management apparatus of claim 7, wherein the second wireless network is wireless Internet.

12. The handover management apparatus of claim 7, wherein
the first wireless network is one of a wireless local area network and a wireless metropolitan area network, and
if the first wireless network is the wireless local area network, the second wireless network is a wireless metropolitan area network and if the first wireless network is the wireless metropolitan are a network, the second wireless network is a wireless local area network.
